(19) United States
(12) Patent Application Publication
(10) Pub. No.: US 2015/0339841 A1
(43) Pub. Date: Nov. 26, 2015

(54) LAYOUT ANIMATION PANEL

(71) Applicant: Microsoft Corporation, Redmond, WA (US)

(72) Inventors: Benjamin Franklin Carter, Redmond, WA (US); Jesse Michael Benson, Bothell, WA (US); Galen Elias, Bellevue, WA (US); Anthony J. Beeman, Seattle, WA (US); Tyler Robert Adams, Seattle, WA (US)

(73) Assignee: MICROSOFT CORPORATION, Redmond, WA (US)

(21) Appl. No.: 14/284,690

(22) Filed: May 22, 2014

(51) Int. Cl. G06T 13/80; G06F 17/21

(52) U.S. Cl. CPC G06T 13/80; G06F 17/212; G06T 2213/08

(57) ABSTRACT

Layout animation that automatically plays in response to a change in layout on UI platforms that typically require animations to be defined prior to the layout being calculated is provided. Developers are enabled to specify how one or more elements should animate via animation values that are relative to an unknown initial layout and an unknown final layout. When a property change event that triggers animation of an element occurs, the initial layout and the final layout of the element and its child elements are calculated. The animations are then scheduled to interpolate the changes in layout.

### BACKGROUND

In contemporary computing systems, user interfaces have been developed for allowing users to interact with electronic content and underlying software application functionality. As computing devices and display functionality become more advanced, users expect graphical displays to be both functionally efficient and visually pleasing. In a dynamic user interface, animations may be used to enrich the user experience by helping to guide users' attention to certain elements and to help ease the transition between different layouts. For example, in an application, such as a word processing application, a user action may trigger a task pane to be displayed. To provide a functionally efficient and visually pleasing experience, a designer may use animation to transition the task pane into view and to resize other displayed panes and containers and their contents to provide for display of the task pane.

Current platforms that are used to build user interfaces (Us) do not natively support easy ways to define animation, in particular, animation to change layout (e.g., position, size, and arrangement of elements). Some infrastructures support animation through storyboards, which are non-visual elements that may be used to orchestrate an animation sequence. Animations may be executed through a declarative language, such as Extensible Application Markup Language (XAML), wherein UI states and transitions may be defined using an Application Programming interface (API). When authoring animations of layout changes of containers and their contents using current user interface (UI) platforms, aspects of the animations, such as the final layout position, size, arrangement of UI elements, etc. may need to be defined in advance. However, until layout is run, the final layout position, size, and arrangement of the UI elements may not necessarily be known, making it difficult to schedule animations of layout changes up front.

Some UI platforms provide for automatically calculating layout properties, wherein the position and arrangement of elements may be calculated and determined on every frame that is presented to the screen. As can be appreciated, calculation of an animation transitioning from an outgoing position, size, and visibility to an incoming position, size, and visibility on each frame may have a performance cost, for example, a reduced animation frame rate. It is with respect to these and other considerations that the present invention has been made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Embodiments of the present invention solve the above and other problems by providing layout animation that automatically plays in response to a change in layout on UI platforms that do not support animations that automatically play in response to a change in layout and that typically require animations to be defined prior to the layout being calculated. Developers are enabled to specify how one or more elements should animate via animation values that are relative to an unknown initial layout and an unknown final layout. When a property change event that triggers animation of an element occurs, the initial layout and the final layout of the element and its child elements are calculated. The animations are then scheduled to interpolate the changes in layout.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of one embodiment of a system for providing layout animation;

FIG. 2A is an illustration of an example user interface displaying a before layout prior to display of a task pane;

FIG. 2B is an illustration of the example user interface of FIG. 2A displaying an after layout after animation of the display of the task pane and resizing of a displayed document;

FIG. 3 is a flow chart of a method for providing layout animation;

FIG. 4 is a block diagram illustrating example physical components of a computing device with which embodiments of the invention may be practiced;

FIGS. 5A and 5B are simplified block diagrams of a mobile computing device with which embodiments of the present invention may be practiced; and

FIG. 6 is a simplified block diagram of a distributed computing system in which embodiments of the present invention may be practiced.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

Embodiments of the present invention are directed to providing automatic layout animation of child elements in response to layout or visual changes. As will be described in detail below, embodiments of the present invention enable animations to be defined on child elements that specify how elements should animate in response to unknown changes in layout.

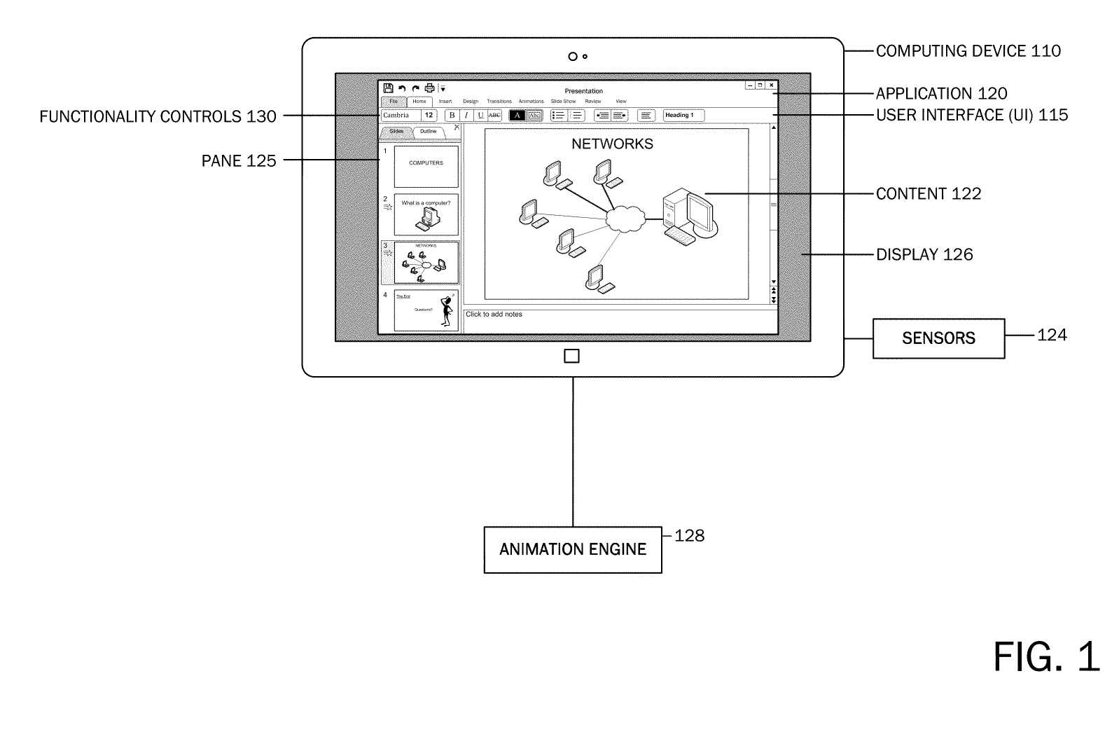

Referring now to the drawings, in which like numerals represent like elements, various embodiments will be described. FIG. 1 is a block diagram illustrating a system architecture 100 for providing automatic layout animation of child elements in response to layout or visual changes. The network architecture 100 includes a computing device 110. The computing device 110 may be one of various types of computing devices (e.g., a tablet computing device (as illustrated), a desktop computer, a mobile communication device, a laptop computer, a laptop/tablet hybrid computing device, a large screen multi-touch display, a gaming device, a smart television, or other types of computing devices) for executing applications 120 for performing a variety of tasks.

A user may utilize an application 120 on a computing device 110 for a variety of tasks, which may include, for example, to write, calculate, draw, organize, prepare presentations, send and receive electronic mail, take and organize notes, make music, and the like. Applications 120 may include thick client applications, which may be stored locally on the computing device 110 (as illustrated in FIG. 1), or may include thin client applications (i.e., web applications) that may reside on a remote server and accessible over a network, such as the Internet or an intranet. A thin client application may be hosted in a browser-controlled environment or coded in a browser-supported language and reliant on a common web browser to render the application executable on a computing device 110. The computing device 110 may be configured to receive content 122 for presentation on a display 126 (which may comprise a touch screen display).

An application 120 may be configured to enable a user to use a pointing device (e.g., a mouse, pen/stylus, etc.) and/or to utilize sensors 124 (e.g., touch sensor, accelerometer, hover sensor, facial recognition, voice recognition, light sensor, proximity sensor, gyroscope, tilt sensor, GPS, etc.) on the computing device 110 to interact with content 122 via a number of input modes.

To assist users to locate and utilize functionalities of a given application 120, a user interface (UI) 115 containing a plurality of selectable functionality controls 130, panes 125, containers 135 (e.g., user content display area, etc.), and other UI elements may be provided. In FIG. 1, an example software application user interface 115 and example associated user content 122 are displayed on the display 126 of the computing device 110. The user interface 115 is illustrative of user interfaces and associated user content enabled by a variety of software applications 120, for example, word processing applications, spreadsheet applications, slide presentation applications, electronic mail applications, notes applications, calendaring applications, and the like. That is, the user interface 115 is illustrative of any graphical display components that may be displayed onto a computer-enabled display 126 for review and use according to associated software application functionality.

The example user interface 115 illustrated in FIG. 1 is illustrative of a slide presentation application user interface having a plurality of functionality controls 130, a pane 125, and a user content display area (i.e., container 135). As should be understood, the illustrated user interface 115 is for purposes of example only and is not limiting of the vast number and types of graphical display components that may be displayed and managed according to embodiments of the invention described herein.

The animation engine 128 is illustrative of one or more software applications that enables animation of display components of software application user interfaces and user content. The animation engine 128 may be operable to enable animations to be defined on child elements that specify how elements should animate in response to unknown changes in layout. In order to enable smooth animations with high animation frame rates, the animation engine 128 may use animation process threads, such as a UI thread, a compositor thread, and a rendering thread. Display behavior may be optimized and controlled by utilizing a declarative markup language, such as the Extensible Application Markup Language (XAML), for defining display behavior functionality and properties.

According to embodiments, a user, such as a designer or developer, may be able to specify animation values relative to unknown initial and final layouts (e.g., positions, size, and arrangement). For example, prior to embodiments of the present invention, if a developer wanted to animate a UI element, he/she may have created a storyboard and specified a starting position and a final position of the element. As can be appreciated, it can be complex to know the initial and final positions or to write code to determine the final positions of elements. Embodiments of the present invention enable developers to specify how an element should animate when it changes (e.g., duration, acceleration, etc.) without specifying the element's specific starting or ending positions.

As briefly described above, in order to author animations of layout changes and to avoid performance costs of calculating layout on each frame, the animation engine 128 is operable to receive animation values relative to unknown initial and final layouts (e.g., positions, size, opacity, arrangement, etc.). Upon receiving an indication of a change in layout or properties of a child element, the animation engine 128 may be further operable to automatically determine the initial and final layouts of the child elements to dynamically create and trigger custom animations of layout changes. Accordingly, layout animation that does not require upfront knowledge of layout changes may is enabled for UI platforms that require a developer to define initial and final layouts.

As mentioned, a designer/developer may be enabled to specify an animation value relative to unknown initial and final layouts. For example, a developer may define an animation as relative to its final position without specifying what the final position is. A developer may want to add a new item to a list. A desired animation may be that he/she wants the new item to fly in and type from off-screen. The relative-to value that the developer may specify is that at time equals zero, the item's initial position is relative to final minus the animation time, for example, 367 milliseconds. The developer may be enabled to mark points in time as relative to a final position, wherein the animation engine 128 may be operable to calculate the before and after layouts based on what occurs and plug in the final values. Accordingly, the work of determining initial and final layout locations may be moved from the application developer to the animation engine 128.

The animation engine 128 may be further operable to animate resizing of elements without stretching their contents or borders and without calculating layout on every frame. Currently, position and arrangement of each element may be calculated on every frame in response to a layout change, which may reduce the frame rate of the animation. Embodiments of the present invention provide for determining before and after layout and faking resize animations with animations that do not affect other elements and thus do not cause layout to be calculated on every frame of the animation. Accordingly, the performance cost of calculating layout on each frame may be avoided.

Resizing an element is a change in layout that may involve moving the element's children and surrounding elements. The before and after layout of each element may be calculated, and the difference may be interpolated without calculating the layout on every frame. Once scheduled, the animation may play independently on the compositor thread. The animation engine 128 may then fake the resize animation with scale and clip animations, which do not affect the layout of other elements, and thus do not require calculations on every frame.

For example, in an application 120, a user may choose to resize a task pane 125 comprising child elements, such as titles and buttons. The developer may not want for text in child elements to stretch or shrink when resized. The animation engine 128 may run a layout calculation once to determine the before and after layout, and then fake the resize without actually resize any elements. Scales and clips, which do not cause a re-layout of elements, may be used instead of actually resizing the task pane 125. For example, the task pane 125 may be clipped and scaled to appear like a resize without the expense of resizing.

According to an embodiment, to fake square border animations that do not stretch and do not calculate layout on every frame, the animation engine 128 may be operable to turn each edge of the border into its own element whose scale is animated in one direction. According to another embodiment, if the position of a child element changes as a result of a layout change and if the child element has an animation on it that specifies that it should animate changes in position, the animation engine 128 may be further operable to animate the changes in position using render transforms, which do not affect other elements. Accordingly, calculation of layout on every frame of the animation may be avoided.

The animation engine 128 may be operable to provide default layouts, alleviating the need for developers to have to author layouts for common scenarios. For example, default layouts may include a stack layout, a grid layout, a wrap grid layout, a dock layout, etc. The animation engine 128 may provide support for implicit animation. For example, switching between a stack layout and a grid layout, the animation engine 128 may provide for automatically animating the layout change.

Developers may be enabled to create their own custom layouts to be used by the animation engine 128. Accordingly, developers may have control over aspects of child element positions and sizes. Embodiments support pluggable layouts and implicit animations that may be triggered on layout or visual changes. Animations and triggers may be specifiable on each panel and/or individual elements in the panel. For example, this may allow top-level frames to specify the animation of pane entrance, lists to specify how their children appear and/or disappear, and galleries to specify how their content reflows.

To create a pluggable layout, developers may create a class that has measure and arrange methods that may be called by the animation engine 128. As an example of a measure method, when layout changes, measure may be called to determine the size required to fit child elements. The panel may be resized accordingly. As an example of an arrange method, child elements may be positioned, and arrange may be called to determine sizes of the child elements when the layout changes.

According to an embodiment and as described above, developers may be enabled to specify animations that automatically trigger in response to layout changes (e.g., position, size, scale, element add/delete, etc.) or visual changes (e.g., scale, visibility, opacity, rotation, projection, etc.) of child elements. For example, a developer may specify how an element is to animate when an animatable property changes. According to an embodiment, if an animation is associated with a trigger and its corresponding property changes, the animation engine 128 may be operable to take a snapshot of the before layout or property. If the layout changes, the layout may be run without updating the screen in order to take a snapshot of the after layout. Storyboards may be created for every element involved in layout. The storyboards may then be animated.

Animations may be designed to be responsive. Accordingly, an animation may be interrupted at any time. Embodiments may provide for support of smooth animation interruption. For example, if a new layout animation is triggered on an element while it is currently animating, the animation engine 128 may stop the animation towards the element's original change in layout and smoothly start an animation towards its new change in layout. To achieve smooth animation interruption, a hard coded starting value or position may need to be unspecified, ensuring that storyboards do not specify a from value.

Embodiments may provide support for batching animation triggers to ensure that animations in response to multiple triggers occur at the same time. Additionally, synchronizing panel animations with animations in other panels may be supported.

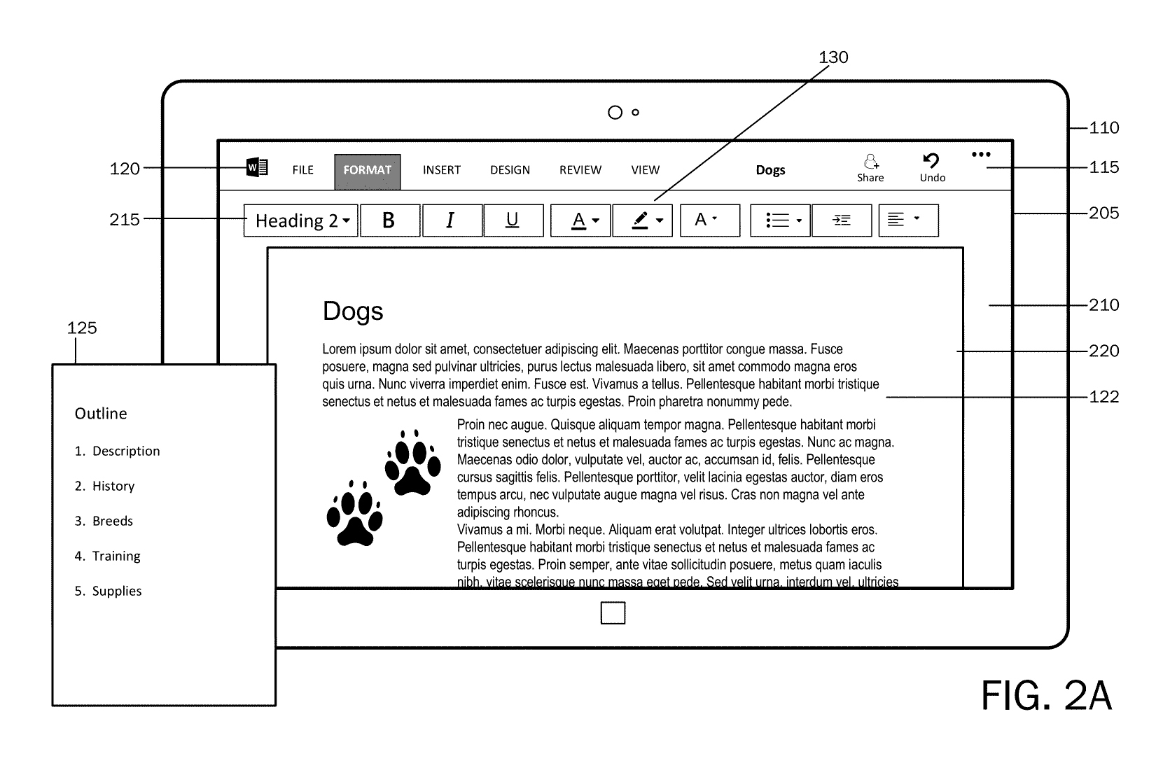

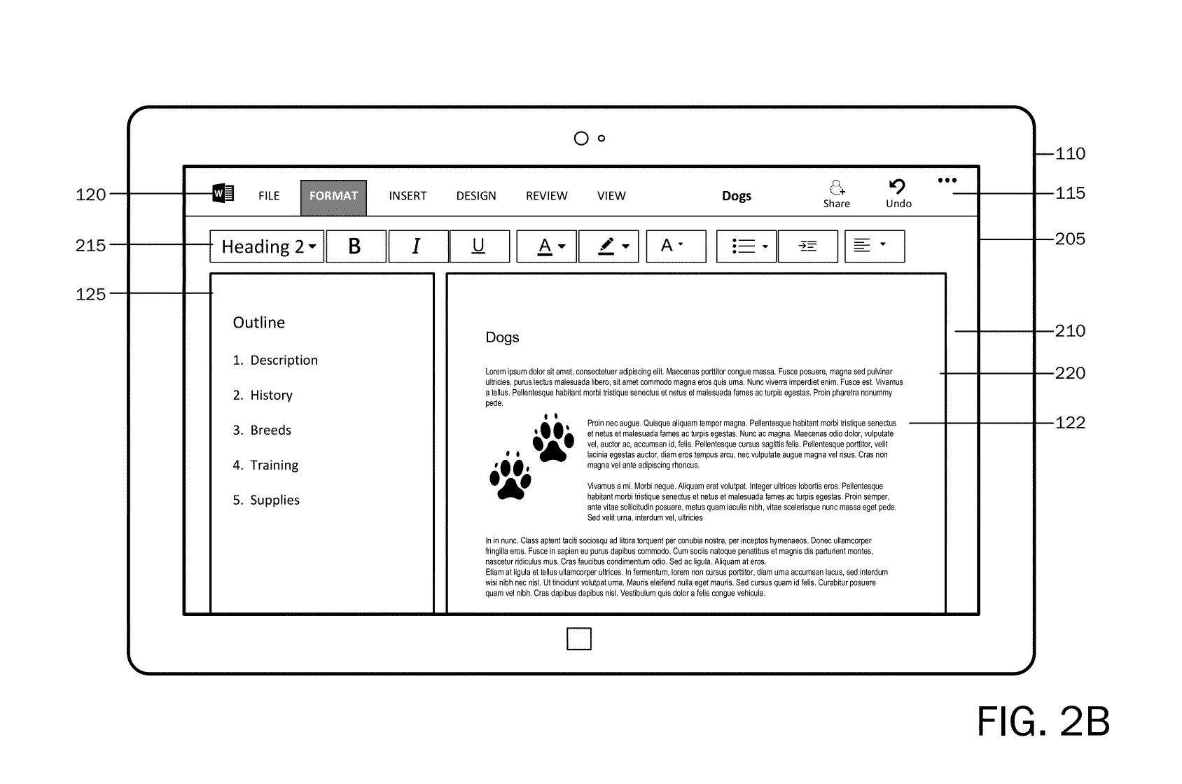

For purposes of describing the animation functionality described herein, FIG. 2A illustrates an example displayed word application user interface associated with a displayed word processing document 220 where each of the displayed user interface components contains a plurality of display components. For example, the user interface 115 may be illustrative of a word processing document. Each display component displayed on a computer screen display 126 may be displayed as a single display object or as a collection of display objects. According to one embodiment, content items may be displayed in a display frame or window in which a collection of display components may be organized for providing a desired display of software application functionality and associated user content.

Referring now to FIG. 2A, the user interface 115 includes a top level panel 205 or container object and may include a number of sub or child display frames or windows 210, 215, 125. For example, a collection of software application functionality buttons or controls 130 may be displayed in a sub or child display frame or window 215, user content 122 may be displayed in a sub or child display frame or window (e.g., document canvas) 210, and functionality and content associated with a service or task pane (e.g., search functions, help functions, information functions, formatting functions, etc.) may be displayed in a sub or child display frame or window 125. As should be appreciated, the example word processing user interfaces and associated user data illustrated in FIGS. 2A and 2B are for purposes of example and illustration only and are not limiting of the vast number and types of user interfaces 115 and associated user data that may be displayed and that may be managed according to embodiments of the present invention.

In FIG. 2A, the illustrated task pane 125 is off screen and may be animated into display, for example, upon receiving an indication of a selection to display the task pane 125. The final position of the pane 125 may be calculated, and the layout of child elements affected by the change may be calculated the document canvas 210 and its child elements (e.g., document 220)). As described above, synchronization of animations using different animation systems may be synchronized. For example, if the task pane 125 animating into display is provided by one animation system and resizing and moving of the document canvas 210 and the document 220 are provided by another animation system, the layout changes may be interpolated, synchronized, and scheduled. The animations may then be played, wherein the task pane 125 and the document canvas 210 and document 220 may be animated into their final layouts as illustrated in FIG. 2B.

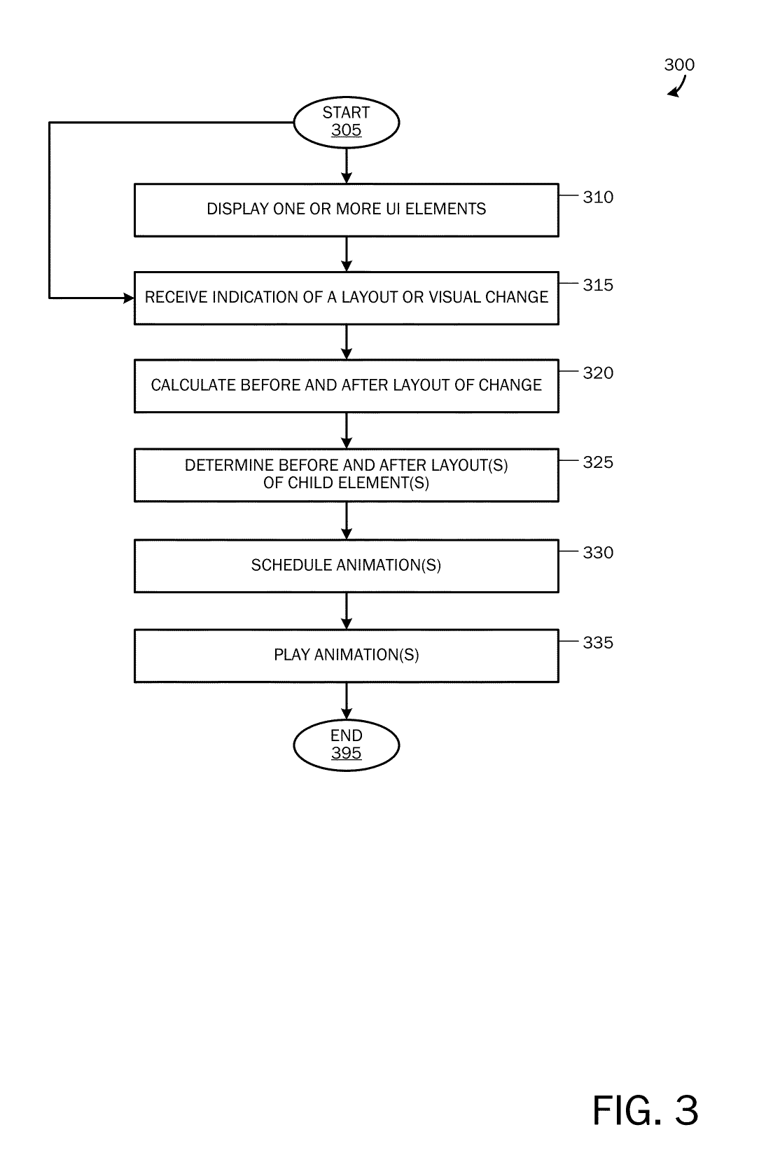

FIG. 3 is a flow chart showing one embodiment of a method 300 for providing layout animation. The method 300 starts at OPERATION 305 and may either proceed to OPERATION 310 where one or more UI elements are displayed in a panel 205 or other container object in a software application user interface 115, or may proceed to OPERATION 315. An example of OPERATION 310 is illustrated in FIG. 2A, where the panel 205 comprises two child UI elements, a ribbon toolbar and a document canvas 120. Each of the child UI elements also comprises child elements. For example, the UI functionality buttons and controls 130 are child elements of the ribbon toolbar and the document 220 is a child clement of the document canvas 120.

At OPERATION 315, an indication of a trigger is received, wherein the trigger may be a property change such as layout changes (e.g., position, size, scale, element add/delete, etc.) or visual changes (e.g., scale, visibility, opacity, rotation, projection, etc.). For example and referring again to FIG. 2A, a trigger may include a property change such as display of a task pane 125.

According to embodiments, an animation behavior may be applied to a visual UI element defining how the visual UI element may animate in response to a trigger. The animation behavior may specify animation values that are relative to unknown initial and final layouts. At OPERATION 320, the animation engine 128 may look to see if an animation behavior has been defined on the UI element by a developer and may calculate the before layout (e.g., prior to the pane 125 being displayed on screen) and the after layout (e.g., after the pane 125 is in position).

At OPERATION 325, the animation engine 128 may determine how the property change may change the layout of child UI elements, and the before and after layouts of the child UI elements may be calculated. At OPERATION 325, the animation engine 128 may be further operable to determine if any layout animations have been defined on the child UI elements.

At OPERATION 330, the animations may be scheduled. Additionally, if an animation is in another panel, the animations may be synchronized. For example, as illustrated in FIG. 2B, display of the task pane 125 may cause the size of the document canvas 210 to change size. Accordingly, the size of the document 220 may also change. Any defined animations with respect to resizing of the document canvas 210 and its child elements may be calculated, scheduled, and synchronized with the animation of the appearance of the task pane 125.

At OPERATION 335, the animations may play. The method 300 ends at OPERATION 395.

While the invention has been described in the general context of program modules that execute in conjunction with an application program that runs on an operating system on a computer, those skilled in the art will recognize that the invention may also be implemented in combination with other program modules. Generally, program modules include routines, programs, components, data structures, and other types of structures that perform particular tasks or implement particular abstract data types.

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

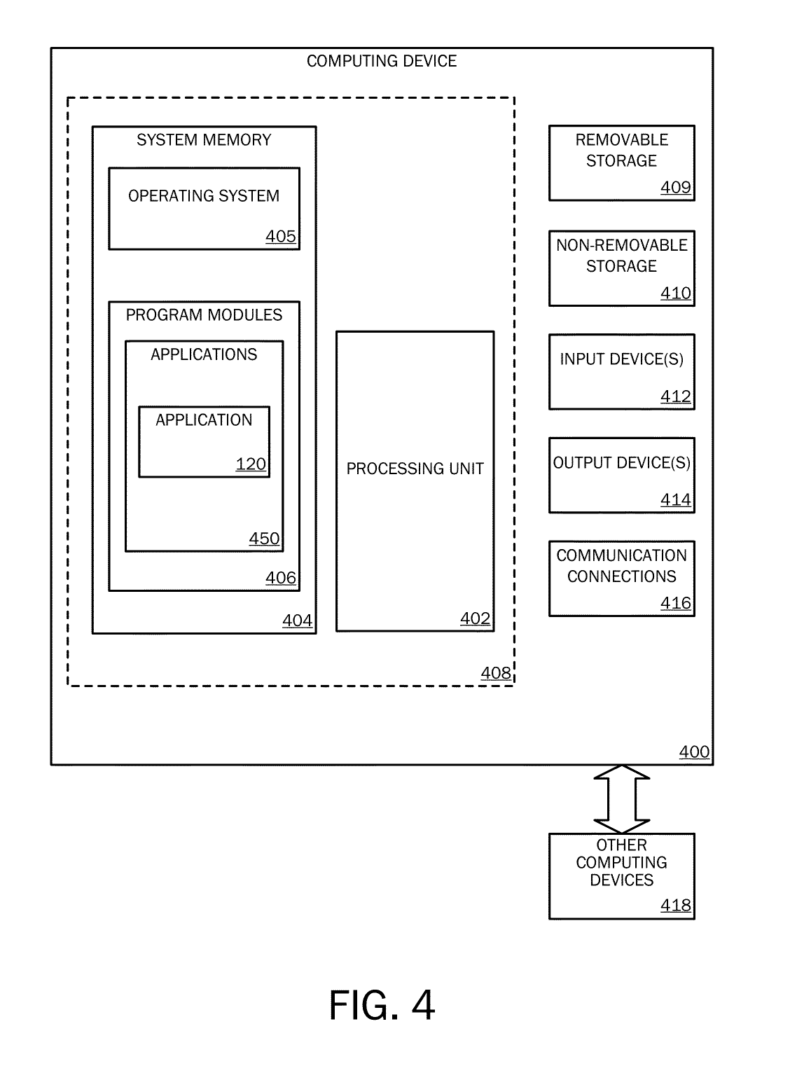

FIGS. 4-6 and the associated descriptions provide a discussion of a variety of operating environments in which embodiments of the invention may be practiced. However, the devices and systems illustrated and discussed with respect to FIGS. 4-6 are for purposes of example and illustration and are not limiting of a vast number of computing device configurations that may be utilized for practicing embodiments of the invention, described herein.

FIG. 4 is a block diagram illustrating physical components (i.e., hardware) of a computing device 400 with which embodiments of the invention may be practiced. The computing device components described below may be suitable for the computing device 110 described above. In a basic configuration, the computing device 400 may include at least one processing unit 402 and a system memory 404. Depending on the configuration and type of computing device, the system memory 404 may comprise, but is not limited to, volatile storage (e.g., random access memory), non-volatile storage (e.g., read-only memory), flash memory, or any combination of such memories. The system memory 404 may include an operating system 405 and one or more program modules 406 suitable for running software applications 450 such as client application 120. The operating system 405, for example, may be suitable for controlling the operation of the computing device 400. Furthermore, embodiments of the invention may be practiced in conjunction with a graphics library, other operating systems, or any other application program and is not limited to any particular application or system. This basic configuration is illustrated in FIG. 4 by those components within a dashed line 408. The computing device 400 may have additional features or functionality. For example, the computing device 400 may also include additional data storage devices (removable and/or non-removable) such as, for example, magnetic disks, optical disks, or tape. Such additional storage is illustrated in FIG. 4 by a removable storage device 409 and a non-removable storage device 410.

As stated above, a number of program modules and data files may be stored in the system memory 404. While executing on the processing unit 402, the program modules 406 may perform processes including, but not limited to, one or more of the stages of the method 300 illustrated in FIG. 3. Other program modules that may be used in accordance with embodiments of the present invention and may include applications such as electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to providing layout animation may be operated via application-specific logic integrated with other components of the computing device 400 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 400 may also have one or more input device(s) 412 such as a keyboard, a mouse, a pen, a sound input device, a touch input device, etc. The output device(s) 414 such as a display, speakers, a printer, etc. may also be included. The aforementioned devices are examples and others may be used. The computing device 400 may include one or more communication connections 416 allowing communications with other computing devices 418. Examples of suitable communication connections 416 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

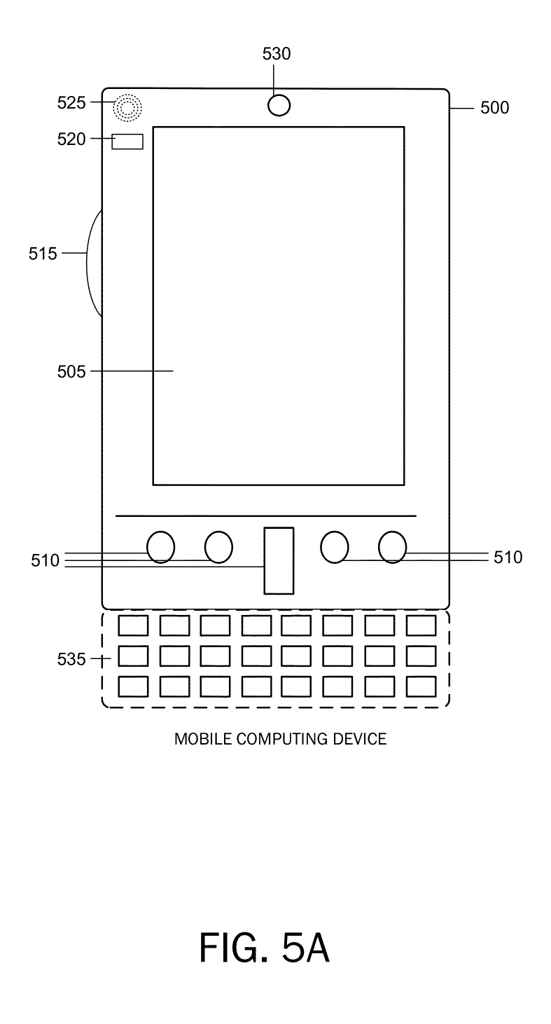

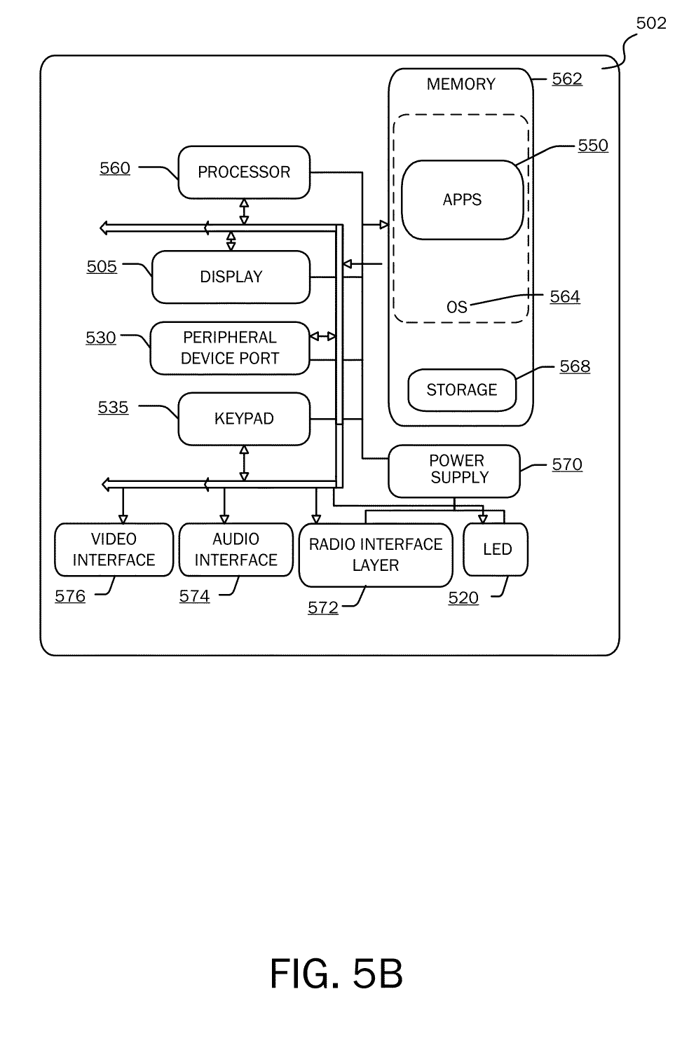

FIGS. 5A and 5B illustrate a mobile computing device 500, for example, a mobile telephone, a smart phone, a tablet personal computer, a laptop computer, and the like, with which embodiments of the invention may be practiced. With reference to FIG. 5A, one embodiment of a mobile computing device 500 for implementing the embodiments is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. The display 505 of the mobile computing device 500 may also function as an input device (e.g., a touch screen display). If included, an optional side input element 515 allows further user input. The side input element 515 may be a rotary switch, a button, or any other type of manual input element. In alternative embodiments, mobile computing device 500 may incorporate more or less input elements. For example, the display 505 may not be a touch screen in some embodiments. In yet another alternative embodiment, the mobile computing device 500 is a portable phone system, such as a cellular phone. The mobile computing device 500 may also include an optional keypad 535. Optional keypad 535 may be a physical keypad or a “soft” keypad generated on the touch screen display. In various embodiments, the output elements include the display 505 for showing a graphical user interface (GUI), a visual indicator 520 (e.g., a light emitting diode), and/or an audio transducer 525 (e.g., a speaker). In some embodiments, the mobile computing device 500 incorporates a vibration transducer for providing the user with tactile feedback. In yet another embodiment, the mobile computing device 500 incorporates input and/or output ports, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one embodiment of a mobile computing device. That is, the mobile computing device 500 can incorporate a system (i.e., an architecture) 502 to implement some embodiments. In one embodiment, the system 502 is implemented as a “smart phone” capable of running one or more applications (e.g., browser, e-mail, calendaring, contact managers, messaging clients, games, and media clients/players). In some embodiments, the system 502 is integrated as a computing device, such as an integrated personal digital assistant (PDA) and wireless phone.

One or more application programs 550 may be loaded into the memory 562 and run on or in association with the operating system 564. Examples of the application programs include phone dialer programs, e-mail programs, personal information management (PIM) programs, word processing programs, spreadsheet programs, Internet browser programs, messaging programs, and so forth. The system 502 also includes a non-volatile storage area 568 within the memory 562. The non-volatile storage area 568 may be used to store persistent information that should not be lost if the system 502 is powered down. The application programs 550 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500.

The system 502 has a power supply 570, which may be implemented as one or more batteries. The power supply 570 might further include an external power source, such as an AC adapter or a powered docking cradle that supplements or recharges the batteries.

The system 502 may also include a radio 572 that performs the function of transmitting and receiving radio frequency communications. The radio 572 facilitates wireless connectivity between the system 502 and the “outside world,” via a communications carrier or service provider. Transmissions to and from the radio 572 are conducted under control of the operating system 564. In other words, communications received by the radio 572 may be disseminated to the application programs 150 via the operating system 564, and vice versa.

The visual indicator 520 may be used to provide visual notifications and/or an audio interface 574 may be used for producing audible notifications via the audio transducer 525. In the illustrated embodiment, the visual indicator 520 is a light emitting diode (LED) and the audio transducer 525 is a speaker. These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. In accordance with embodiments of the present invention, the microphone may also serve as an audio sensor to facilitate control of notifications, as will be described below. The system 502 may further include a video interface 576 that enables an operation of an on-board camera 530 to record still images, video stream, and the like.

A mobile computing device 500 implementing the system 502 may have additional features or functionality. For example, the mobile computing device 500 may also include additional data storage devices (removable and/or non-removable) such as, magnetic disks, optical disks, or tape. Such additional storage is illustrated in FIG. 5B by the non-volatile storage area 568.

Data/information generated or captured by the mobile computing device 500 and stored via the system 502 may be stored locally on the mobile computing device 500, as described above, or the data may be stored on any number of storage media that may be accessed by the device via the radio 572 or via a wired connection between the mobile computing device 500 and a separate computing device associated with the mobile computing device 500, for example, a server computer in a distributed computing network, such as the Internet. As should be appreciated such data/information may be accessed via the mobile computing device 500 via the radio 572 or via a distributed computing network. Similarly, such data/information may be readily transferred between computing devices for storage and use according to well-known data/information transfer and storage means, including electronic mail and collaborative data/information sharing systems.

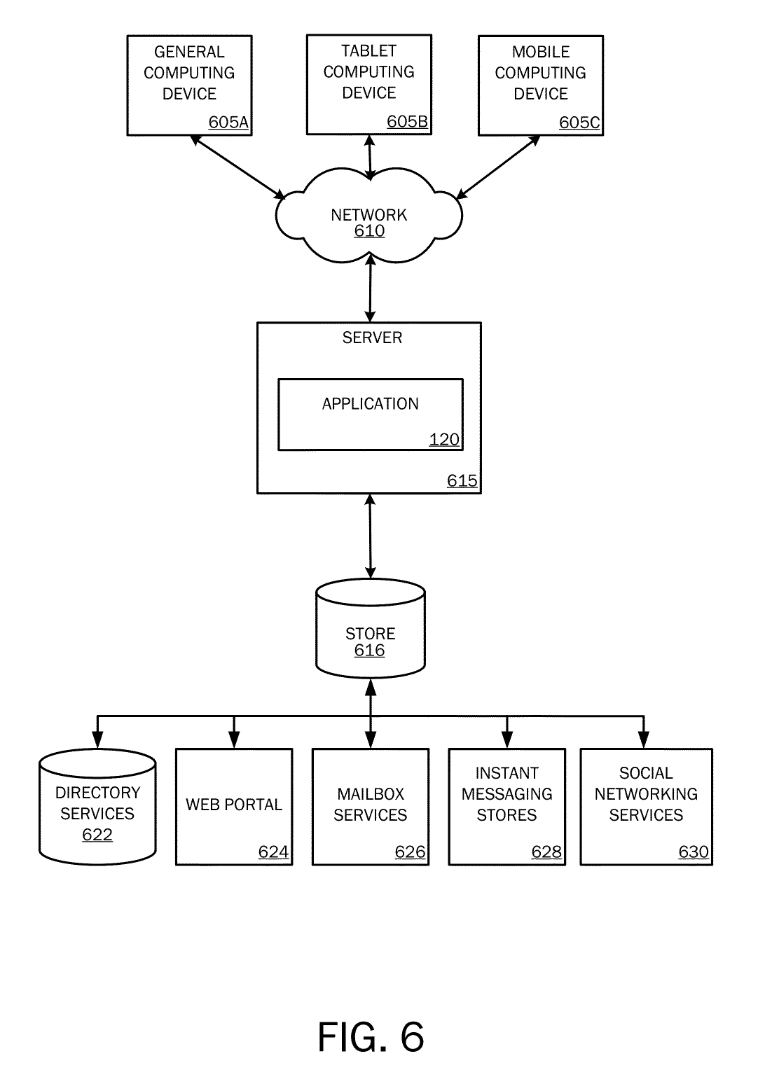

FIG. 6 illustrates one embodiment of the architecture of a system for providing layout animation, as described above. Content developed, interacted with, or edited in association with the application 120 may be stored in different communication channels or other storage types. For example, various documents may be stored using a directory service 622, a web portal 624, a mailbox service 626, an instant messaging store 628, or a social networking site 630. The application 120 may use any of these types of systems or the like for providing layout animation, as described herein. A server 615 may provide the application 120 to clients 110. As one example, the server 615 may be a web server providing the application 120 over the web. The server 615 may provide the application 120 over the web to clients 110 through a network 610. By way of example, the client computing device 110 may be implemented and embodied in a personal computer 605A, a tablet computing device 605B and/or a mobile computing device 605C (e.g., a smart phone), or other computing device. Any of these embodiments of the client computing device may obtain content from the store 616.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

We claim:

1. A computer-implemented method of animating a computer-generated display element, the method comprising:
receiving an indication of a property change of a user interface element;
calculating an initial layout and a final layout of the property change;
identifying changes of child elements in response to the property change;
identifying one or more animations defined on the child elements; and
scheduling the defined animations of the user interface element and the child elements for play.

2. The computer-implemented method of claim 1, wherein scheduling the defined animations of the user interface element and the child elements for play comprises interpolating a change in layout from the initial layout to the final layout.

3. The computer-implemented method of claim 1, wherein receiving an indication of a property change comprises receiving an indication of a layout or visual change that triggers an animation.

4. The computer-implemented method of claim 1, wherein identifying one or more animations defined on the child elements comprises identifying specified animation values relative to an unknown initial layout and an unknown final layout.

5. The computer-implemented method of claim 1, wherein identifying one or more animations defined on the child elements comprises:
identifying a resize animation defined on a child element;
determining the initial layout and the final layout of the child element; and
scheduling scale and clip animations instead of the resize animation.

6. The computer-implemented method of claim 1, wherein identifying one or more animations defined on the child elements comprises identifying one or more animations defined on the child elements according to a declarative markup language.

7. The computer-implemented method of claim 1, wherein scheduling the defined animations of the user interface element and the child elements for play comprises synchronizing the defined animations of the user interface element and the child elements with animations in other panels.

8. The computer-implemented method of claim 1, further comprising batching animation triggers.

9. A system for animating a computer-generated display element, comprising:
one or more processors; and
a memory coupled to the one or more processors, the one or more processors operable to:
receive an indication of a property change of a user interface element;
calculate an initial layout and a final layout of the property change;
identify changes of child elements in response to the property change;
identify one or more animations defined on the child elements; and
schedule the defined animations of the child elements.

10. The system of claim 9, wherein in scheduling a defined animation of a child element, the one or more processors are further operable to interpolate a change in layout from the initial layout to the final layout.

11. The system of claim 9, wherein in receiving an indication of a property change, the one or more processors are operable to receive an indication of a layout or visual change that triggers an animation.

12. The system of claim 9, wherein in identifying one or more animations defined on the child elements, the one or more processors are further operable to identify specified animation values relative to an unknown initial layout and an unknown final layout.

13. The system of claim 9, wherein in identifying one or more animations defined on the child elements, the one or more processors are further operable to:
identify a resize animation defined on a child element;
determine the initial layout and the final layout of the child element; and
schedule scale and clip animations instead of the resize animation.

14. The system of claim 9, wherein in scheduling the defined animations of the child elements, the one or more processors are further operable to synchronize the defined animations of the child elements with animations in other panels.

15. A computer readable medium containing computer executable instructions which when executed by a computer perform a method of animating a computer-generated display element, comprising:
receiving an indication of a layout or visual change that triggers an animation of a user interface element;
calculating an initial layout and a final layout of the user interface element;
identifying changes of child elements in response to the property change;
identifying one or more animations defined on the child elements;
scheduling the defined animations of the user interface element and the child elements for play; and
playing the defined animations.

16. The computer readable medium of claim 15, wherein scheduling defined animations of the user interface element and the child elements comprises interpolating a change in layout from the initial layout to the final layout.

17. The computer readable medium of claim 15, wherein identifying one or more animations defined on the child elements comprises:
identifying a resize animation defined on a child element;
determining the initial layout and the final layout of the child element; and
scheduling scale and clip animations instead of the resize animation.

18. The computer readable medium of claim 15, wherein identifying one or more animations defined on the child elements comprises identifying one or more animations defined on the child elements according to a declarative markup language.

19. The computer readable medium of claim 15, wherein scheduling the defined animations of the user interface element and the child elements for play comprises synchronizing the defined animations of the child elements with animations in other panels.

20. The computer readable medium of claim 15, further comprising batching animation triggers.
